(19) United States
(12) Patent Application Publication
(10) Pub. No.: US 2025/0028186 A1
(43) Pub. Date: Jan. 23, 2025

(54) Method for Runtime Temperature-Position Scaling Drift Inaccuracy Compensation in Camera OIS Systems

(71) Applicant: Google LLC, Mountain View, CA (US)

(72) Inventor: Jin Yu Lee, Mountain View, CA (US)

(73) Assignee: Google LLC, Mountain View, CA (US)

(21) Appl. No.: 18/903,922

(22) Filed: Oct. 1, 2024

Related U.S. Application Data
(60) Provisional application No. 63/587,696, filed on Oct. 3, 2023.

(51) Int. Cl. G02B 27/64; G03B 5/00; H04N 23/68

(52) U.S. Cl. CPC G02B 27/646; G03B 5/00; G03B 2205/0007; H04N 23/687

(57) ABSTRACT

This disclosure describes a method to calibrate a position of an optical image stabilization (OIS) lensing element 308 based on a temperature reading. The temperature reading is of one or more sensors, such as a Hall Effect sensor, and the position is a deviation from a center position, which is the position of the OIS lensing element 308 when it is not influenced by a force. A center drift coefficient is generated based on the temperature reading. A derived value for the position is adjusted based on the center drift coefficient. Additionally, a scaling sensitivity coefficient is generated based on the temperature reading. The adjusting of the derived value for the position is further based on the scaling sensitivity coefficient. The center drift coefficient and the scaling sensitivity coefficient are further based on maximum and minimum values for the Hall Effect sensor at the temperature reading and a calibration temperature.

### CROSS-REFERENCE TO RELATED APPLICATION(S)

This application claims the benefit of U.S. Provisional Patent Application Ser. No. 63/587,696, filed on Oct. 3, 2023, the disclosure of which is incorporated by reference herein in its entirety.

### BRIEF SUMMARY

This disclosure describes a method for runtime temperature-position scaling drift inaccuracy compensation in camera optical image-stabilization (OIS) systems. In aspects, the method allows calibration of a position of an OIS lensing element based on a temperature reading. The temperature reading is of one or more sensors, such as a Hall Effect sensor (HES), and the position is a deviation from a center position, where the center position is the position of the OIS lensing element when it is not under the influence of a force. A center drift coefficient (CDC) is generated based on the temperature reading, and a derived value for the position is adjusted based on the CDC. Additionally, a scaling sensitivity coefficient (SSC) is generated based on the temperature reading. The adjusting of the derived value for the position is further based on the SSC. The CDC and SSC are further based on maximum and minimum values for the HES at the temperature reading and a calibration temperature.

### BRIEF DESCRIPTION OF THE DRAWINGS

FIG. 1 illustrates an example environment for a method for runtime temperature-position scaling drift inaccuracy compensation in camera OIS systems, according to aspects of the disclosure;

FIG. 2 illustrates an example mobile device for a method for runtime temperature-position scaling drift inaccuracy compensation in camera OIS systems;

FIG. 3 illustrates an example OIS system for a method for runtime temperature-position scaling drift inaccuracy compensation in camera OIS systems;

FIG. 4 illustrates an example logical flow diagram for a method for runtime temperature-position scaling drift inaccuracy compensation in camera OIS systems.

### DETAILED DESCRIPTION

### Overview

The technology disclosed may generally relate to a method for runtime temperature-position scaling drift inaccuracy compensation in camera optical image-stabilization (OIS) systems. OIS systems can be impacted by thermal fluctuations, such as by temperature changes affecting a readout of a sensor. For example, one or more sensors (Hall Effect sensor (HES), tunneling magnetoresistance (TMR) sensor, etc.) may be used to derive a position of a lensing element of the OIS system, such as a floating lens. In the example where the one or more sensors are an HES, the HES may give a magnetic field reading used to generate a location of a center of the lensing element. Due to thermal fluctuations, the readout from the one or more sensors can, in aspects, provide different generated locations for the center of the lensing element when the lensing element is in the same relative position in space.

An original equipment manufacturer (OEM) may attempt to account for the effects of thermal fluctuations on the sensor via calibration techniques. For example, consider the following equation for calibrating an HES:

$${H}_{Tc} = {H}_{{T}^{′}} + D C ( {H}_{B} \cdot {ω}_{R} \cdot {R}_{{T}^{′}} \cdot \frac{T c - {T}^{′}}{2} ) + {ω}_{M} \cdot {M}_{{T}^{′}} \qquad Eq . 1$$

The variables for Eq. 1 are as follows: HTe is a reading of the HES at a current temperature (Tc), HT is a reading of the HES at a calibration temperature (T′), DC is a current value, which is a function of the variable in parenthesis. H_{B} is a bias term for the HES, ω_{R} is a resistance coefficient, R_{T} is a resistance value at T′, ω_{R} is a magnetic flux coefficient, and M_{T} is a magnetic flux value at T′. This differs from a more-general HES output formula, such as:

$$H = D C ( {H}_{B} \cdot \frac{R}{2} ) + {ω}_{M} \cdot M \qquad Eq . 2$$

In Eq. 2, it is clear to see that the temperature-dependent terms of Eq. 1 are not present. However, even the temperature-dependent terms of in Eq. 1 may not suffice to account for how fluctuating temperatures can affect the output reading of a sensor, such as the HES. For instance, the OEM calibration values (e.g., those derived using Eq. 1) may not account for individual device variations, ambient conditions different than those present when setting values using T′, etc. Further, a calibration as in Eq. 1 may require a multi-physics simulation and/or per-module OIS calibration points tested under different temperatures. The multi-physics simulation and the per-module calibration points may be logistically prohibitive due to time constraints, production costs, or other reasons.

It is more appropriate to account for the possible difference due to thermal fluctuations between the generated center point of the lensing element (e.g., using Eq. 2) and the actual center point by constructing a center drift coefficient (CDC). An example formulation of such a CDC is:

$$C D C = \frac{Δ {H}_{C ( {T}_{1} , {T}_{2} )}}{Δ T} \qquad Eq . 3$$

In Eq. 3, ΔH_{C} is the lens center point, as derived by the sensor (e.g., the HES), T₁ is a first temperature, T₂ is a second temperature, and ΔT is the difference between T₁ and T₂. In some examples, the value for ΔH_{C} may be evaluated as:

$$Δ {H}_{C ( {T}_{1} , {T}_{2} )} = D C ( {H}_{B} \cdot {ω}_{R} \cdot {R}_{{T}^{′}} \frac{Δ T}{2} ) + {ω}_{M} \cdot {M}_{{T}^{′}} \qquad Eq . 4$$

From Eq. 3 and Eq. 4, it is clear to see that:

$$Δ {H}_{C ( {T}_{1} , {T}_{2} )} = CDC \cdot Δ T \qquad Eq . 5$$

According to some examples, a generation of a scaling sensitivity coefficient (SSC) is also used to calibrate the scale of the potential registration values for the HES or other sensor. An example equation for an SSC is:

$$SSC = \frac{Δ {H}_{M , T 2}}{Δ {H}_{M , T 1} \cdot Δ T} \qquad Eq . 6$$

In Eq. 6, ΔH_{M,x} is the difference between the maximum and minimum values possible for the HES at a temperature x. The SSC allows for fine-tuning a sensor value, such as one given by the HES, from the already calibrated value given using the CDC. Although the CDC and SSC coefficients have been shown here, additional coefficients or different formulations for these coefficients may also be used.

The technology is advantageous because it provides reliable calibration of the center point for the lensing element. For example, if the center point for the lensing element is not known by a camera device within an acceptable tolerance, images and/or videos captured using the OIS system can have artifacts, focus problems, irregularities in capture, etc. By using the CDC in calculations of the center point for the lensing element, OIS systems and devices are able to more accurately gauge the center point and, thus, provide an end user of the camera device with better image quality and an improved image capture experience.

### Example Environment

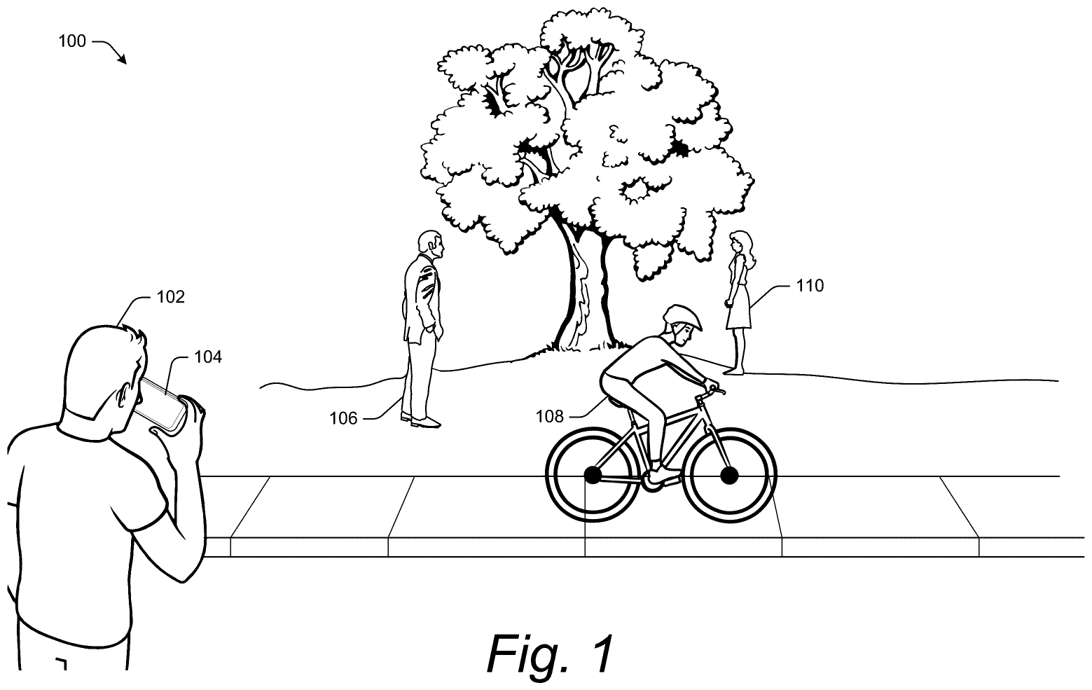

FIG. 1 illustrates an example environment 100 for a method for runtime temperature-position scaling drift inaccuracy compensation in camera OIS systems, according to aspects of the disclosure. The environment 100 includes a user 102. The user is capturing imagery with a mobile device 104. The environment 100 may further include multiple subjects, such as a man 106, a bicyclist 108, and a woman 110.

In the example environment 100, the mobile device 104 used to capture the imagery is held in a hand of the user 102. As such, the mobile device 104 may experience an unwanted movement during image capture, such as shaking or tilting. In order to compensate for the unwanted movement, the mobile device 104 may include an OIS system, such as a floating lens.

Consider the user 102 using the mobile device 104 to capture imagery (photo, video, etc.) of the bicyclist 108. As the bicyclist 108 moves across the scene, the user 102 must track the bicyclist 108 with the mobile device 104. This scenario may introduce the unwanted movement. Consider the OIS system including a floating lens element (not pictured). The floating lens element may help to compensate for the unwanted movement by allowing for some movement of the mobile device 104 with no or less movement of the floating lens element. When the mobile device 104 captures imagery, in aspects, it may require knowledge about a center position of the floating lens element in order to compensate for a corresponding drift point within a camera capture element of the mobile device 104, such as a charged-coupled device (CCD).

### Example Device

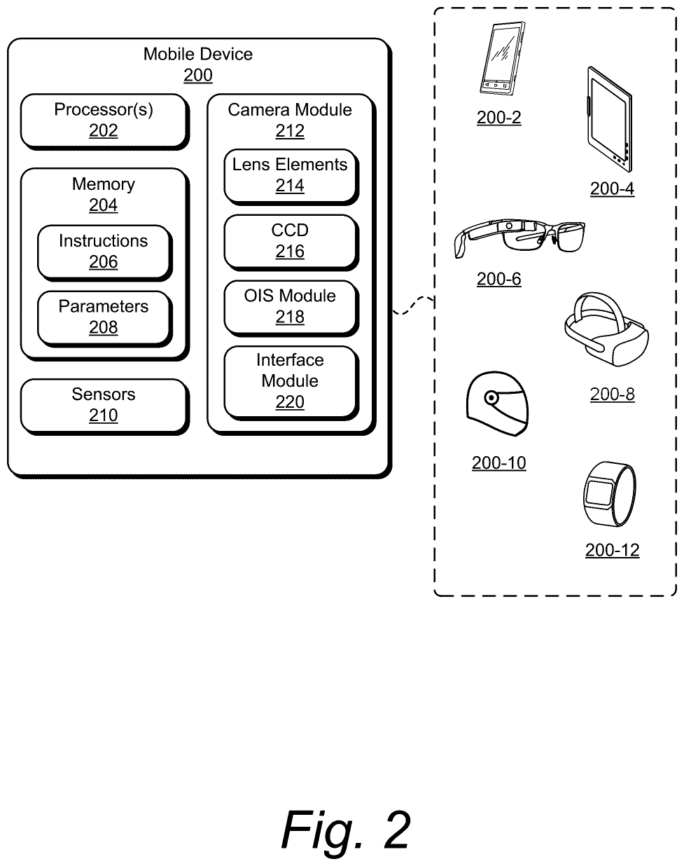

FIG. 2 illustrates an example mobile device 200 for a method for runtime temperature-position scaling drift inaccuracy compensation in camera OIS systems. The mobile device 200 may be, for example, a smart phone 200-2, a tablet device 200-4, smart glasses 200-6, AR goggles or an AR headset 200-8, a smart helmet 200-10, a smart watch 200-12, or any other device known to a person of ordinary skill in the art where such a device is capable of capturing and processing imagery. The list of example devices given is meant to be illustrative and not limiting. The mobile device 200 may be a battery powered device.

The mobile device 200 includes one or more processors 202 and one or more computer-readable media (memory) 204. The memory 204 may include instructions 206, such as those for generating a CDC or an SSC, and parameters 208. The mobile device may also, in some examples, include one or more sensors 210, such as an HES, a TMR sensor, etc. The one or more sensors 210 may, in some examples, use information or data stored in the memory 204 to calibrate output values of the one or more sensors 210. In some examples, the one or more processors 202 may use the instructions 206 and/or the parameters 208 to calibrate or otherwise adjust the output values from the one or more sensors 210.

The mobile device 200 also, in aspects, includes a camera module 212 for image capture, such as still imagery capture or video capture. The camera module 212 includes various elements, such as one or more lens elements 214, a charged-coupled device (CCD) 216, an OIS module 218, an interface module 220 configured to allow a user to interact with the camera module 212, etc. Though depicted as distinct elements in FIG. 2, some elements may be combined in the camera module 212. For example, the OIS module 218 may include the lens element 214 and the CCD 216. Other combinations are possible.

The mobile device 200 may also include other modules and elements not pictured. For example, the mobile device 200 can include a wireless interface, a viewing screen, an input device or module, speakers, a battery, or any number of other elements, devices, and modules common to mobile electronic devices. The elements and modules shown in FIG. 2 are meant to be illustrative and not limiting. Elements, modules, and devices not pictures are omitted for clarity and their absence should need be construed as intentional limitation.

The one or more processors 202 and the memory 204, which includes memory media and storage media, are the main processing complex of the mobile device 200. The instructions 206 and the parameters 208 may, in aspects, be implemented as computer-readable instructions on the memory 204, which may be executed by the one or more processors 202 to provide functionalities described herein, such as the generation of the CDC and the SSC.

The one or more processors 202 may include any combination of one or more controllers, microcontrollers, processors, microprocessors, hardware processors, hardware processing units, digital-signal-processors, graphics processors, graphics processing units, and the like. The one or more processors 202 may be an integrated processor and memory subsystem (e.g., implemented as a “system-on-chip”), which processes computer-executable instructions to control operations of the mobile device 200.

The memory 204 may be, in aspects, configured as persistent and non-persistent storage of executable instructions (e.g., firmware, recovery firmware, software, applications, modules, programs, functions, and the like) and data (e.g., user data, operational data) to support execution of the executable instructions. Examples of the memory 204 include volatile memory and non-volatile memory, fixed and removable media devices, and any suitable memory device or electronic data storage that maintains executable instructions and supporting data. The memory 204 may include various implementations of random-access memory (RAM), read-only memory (ROM), flash memory, and other types of storage memory in various memory device configurations. The memory 204 may exclude propagating signals. The memory 204 may be a solid-state drive (SSD) or a hard disk drive (HDD).

The one or more sensors 210 generally obtain contextual information indicative of operating conditions (virtual or physical) of the mobile device 200 or the surroundings of the mobile device 200. The mobile device 200 monitors the operating conditions based in part on sensor data generated by the one or more sensors 210. Additional examples of the one or more sensors 210 include movement sensors, temperature sensors, position sensors, proximity sensors, light sensors, infrared sensors, moisture sensors, pressure sensors, and the like.

The interface module 220 may, in aspects, act as an output and input component for obtaining user input and providing a user interface. As an output component, the interface module 220 may, in some examples, be a display, a speaker or audio system, a haptic-feedback system, or another system for outputting information to a user (e.g., the user 102). When configured as an input component, the interface module 220 can include a touchscreen, a microphone, a physical button or switch, a radar input system, or another system for receiving input from the user. Other examples of the interface module 220 include a mouse, a keyboard, a fingerprint sensor, or an optical, an infrared, a pressure-sensitive, a presence-sensitive, or a radar-based gesture detection system. The interface module 220 often includes a presence-sensitive input component operatively coupled to (or integrated within) a display.

When configured as a presence-sensitive screen, the interface module 220 detects when the user provides two-dimensional or three-dimensional gestures at or near the locations of a presence-sensitive feature. In response to the gestures, the interface module 220 may output information to other components of the mobile device 200 to indicate relative locations (e.g., X, Y, Z coordinates) of the gestures, and to enable the other components to interpret the gestures. The interface module 220 may output data based on the information generated by an output component or an input component which, for example, may be used to capture imagery using the camera module 212.

### Example Optical Image-Stabilization System

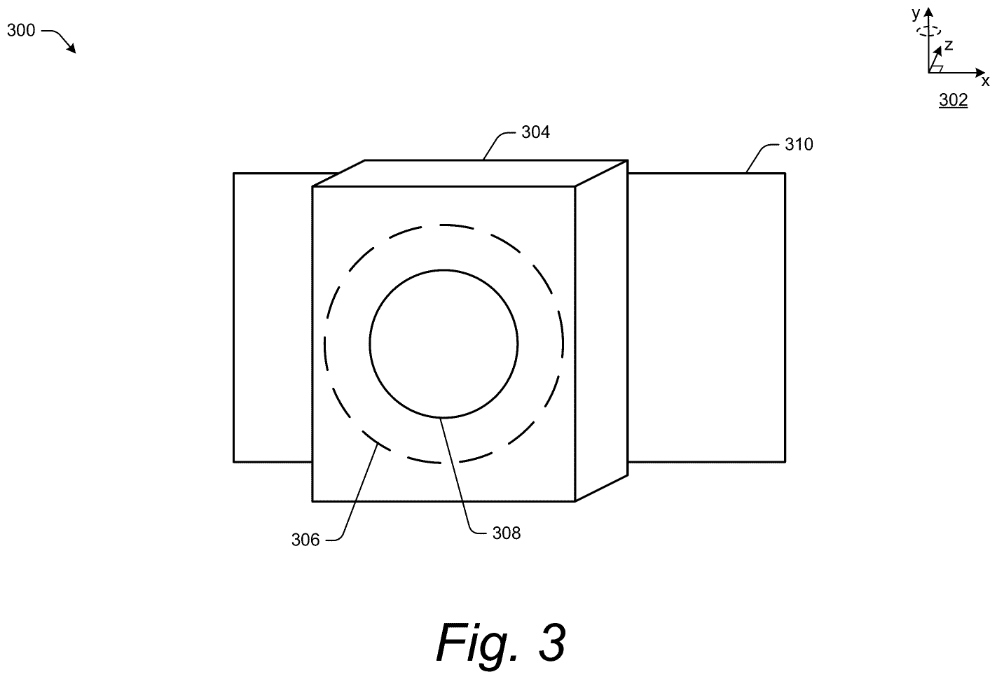

FIG. 3 illustrates an example OIS system 300 for a method for runtime temperature-position scaling drift inaccuracy compensation in camera OIS systems. The OIS system 300 is illustrated with respect to a coordinate system 302, the coordinate system including an x axis, a y axis, and a z axis. The OIS system includes a floating lens assembly 304, the floating lens assembly 304 including a floating coupler 306 and a lens 308. The lens 308 is coupled to a housing of the floating lens assembly 304 via the coupler 306. The OIS system 300 further includes a CCD 310.

The arrangement of the components of the OIS system 300 are shown relative to the coordinate system 302. The lens 308 is substantially parallel with the x-y plane, as is the CCD 310. The lens 308 is arranged such that it is orthogonal to the z axis, as is the CCD 310. As the CCD 310 and the lens 308 are orthogonal to the z axis, light incident on the lens 308 from the z axis direction will also be incident on the CCD 310.

Consider an example when the OIS system 300 is moved, such as by the user 102 moving the electronic device 104 of FIG. 1. The lens 308 will not immediately move with the rest of the OIS system 300 as it is floating in the floating lens assembly 304. However, the CCD 310 is not similarly floating, so a center point of the lens 308 will move relative to the CCD 310. One or more sensors may be used (e.g., the one or more sensors 210 of FIG. 2) to determine a shift in the center point. However, the output of the one or more sensors may be affected by temperature fluctuations within the OIS system 300. An incorrect reading from the one or more sensors may cause a false position determination of the center point of the lens 308. The generation of a CDC, including the possible generation of an SSC, can be used to correct for readings used to determine the center point of the lens 308, as disclosed herein.

### Example Implementation

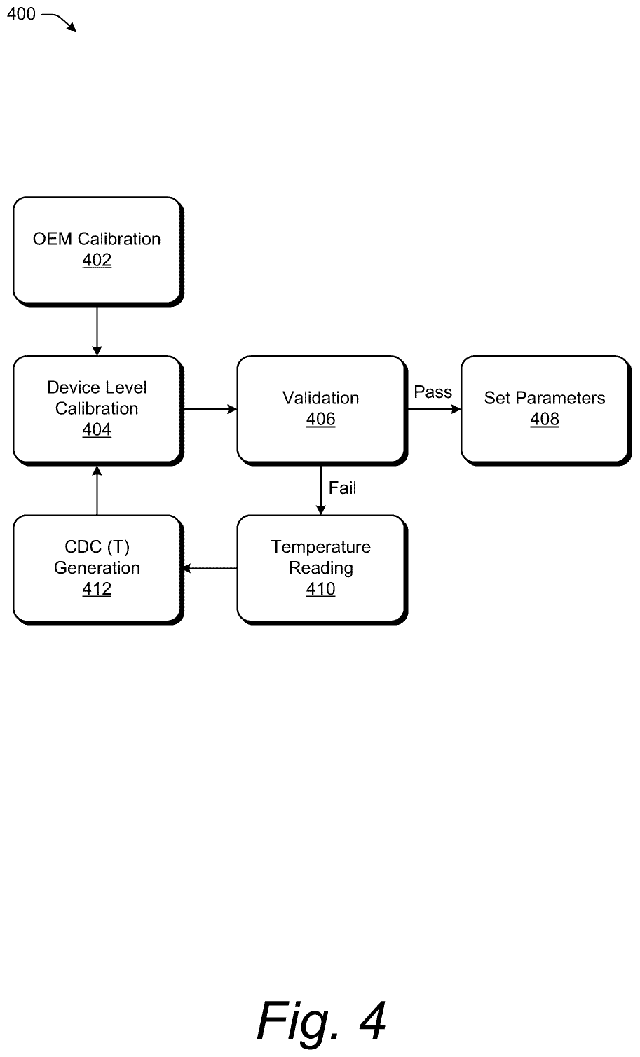

FIG. 4 illustrates an example logical flow diagram 400 for a method for runtime temperature-position scaling drift inaccuracy compensation in camera OIS systems, according to aspects of the disclosure. At 402, an OEM calibration is performed. For example, a mobile image capture device (e.g., the mobile device 200) may be factory calibrated using Eq. 1 or a similar equation. The OEM calibration may not take individual device parameters into account. The OEM calibration may be, in aspects, performed at the time one or more sensors (e.g., the sensors 210) are manufactured.

At 404, a device-level calibration is performed. The device-level calibration, in some examples, accounts for input from one or more sensors of the mobile image capture device, including at least a temperature reading. The device-level calibration, in aspects, uses at least a CDC (e.g., Eq. 3) and may also use an SSC (e.g., Eq. 6). The device-level calibration accounts for a shift in a center position of a lens of an OIS system due to a thermal fluctuation.

At 406, the device-level calibration is validated. For example, one or more processors (e.g., the one or more processors 202) of the mobile imaging device may compare the CDC with a threshold value. The validation, for example, may be a binary validation classification, such as a pass/fail result. If the validation passes, the logical flow diagram 400 proceeds to 408, where one or more parameters are set to account for the shift in the center position of the lens of the OIS system due to the thermal fluctuations. If the validation fails, the logical flow diagram 400 proceeds to 410, where a temperature reading of T is taken. At 412, another CDC value is generated, which is dependent on T. At 404, a new device-level calibration is performed and the logical flow diagram 400 proceeds from there.

According to some examples, CDC and/or SSC values may be stored in a memory of the mobile image capture device (e.g., the parameters 208). In other examples, the CDC and/or SSC values may be generated by the one or more processors. According to some examples, the validation may have a limit on the number of times it can fail to avoid an infinite-loop error.

In some examples where the CDC and/or SSC values are generated by the one or more processors based on the temperature, the CDC and/or SSC values may be compared to previous and/or predetermined CDC and/or SSC values for the temperature, the previous and/or predetermined CDC and/or SSC values for the temperature stored in the memory. In some examples, comparison of the CDC and/or SSC values generated by the one or more processors based on the temperature and the previous and/or predetermined CDC and/or SSC values for the temperature may include updating or otherwise adjusting, by the one or more processors, the CDC and/or SSC values generated by the one or more processors based on the temperature.

### CONCLUSION

While the present subject matter has been described in detail with respect to various specific example implementations thereof, each example is provided by way of explanation, not limitation of the disclosure. Those skilled in the art, upon attaining an understanding of the foregoing, can readily produce alterations to, variations of, and equivalents to such implementations. Accordingly, the subject disclosure does not preclude inclusion of such modifications, variations, and/or additions to the present subject matter as would be readily apparent to one of ordinary skill in the art. For instance, features illustrated or described as part of one implementation can be used with another implementation to yield a still further implementation. Thus, it is intended that the present disclosure cover such alterations, variations, and equivalents.

What is claimed is:

1. A method for optical image stabilization (OIS), the method comprising:
receiving, by one or more processors, a temperature reading from one or more sensors;
comparing, by the one or more processors, the temperature reading to a calibration temperature value;
generating, by the one or more processors and based on the comparison of the temperature reading to the calibration temperature value, a center drift coefficient for an imaging element; and
adjusting, by the one or more processors and based on the generated center drift coefficient, a position value for a lensing element.

2. The method of claim 1, wherein the temperature reading is based on a temperature of a Hall Effect Sensor.

3. The method of claim 2, wherein the center drift coefficient is further generated based on:
a centered value of the Hall Effect Sensor at the temperature reading; and
a centered value of the Hall Effect Sensor at the calibration temperature value.

4. The method of claim 1, further comprising:
comparing, by the one or more processors, the center drift coefficient with a plurality of saved center drift coefficient values, each of the plurality of saved center drift coefficient values associated with a temperature; and
adjusting, by the one or more processors and based on the comparison of the center drift coefficient with the plurality of saved center drift coefficient values, the center drift coefficient.

5. The method of claim 4, wherein the adjusting of the center drift coefficient comprises:
receiving, by the one or more processors, a second temperature reading from the one or more sensors;
comparing, by the one or more processors, the second temperature reading to the calibration temperature value; and
generating, by the one or more processors and based on the comparison of the second temperature reading to the calibration temperature value, a new center drift coefficient for the imaging element.

6. The method of claim 1, wherein the position value for the lensing element is a deviation from a center position, the center position being the position of the lensing element when it is not under the influence of a force.

7. The method of claim 1, further comprising generating, by the one or more processors and based on the temperature reading, a scaling sensitivity coefficient, wherein:
the scaling sensitivity coefficient is based on a maximum possible reading and a minimum possible reading of one or more sensors; and
the adjusting of the position value for the lensing element is further based on the SSC.

8. The method of claim 7, wherein the one or more sensors are a Hall Effect Sensor and the scaling sensitivity coefficient is further generated based on:
a maximum value of the Hall Effect Sensor at the temperature reading;
a minimum value of the Hall Effect Sensor at the temperature reading;
a maximum value of the Hall Effect Sensor at the calibration temperature value; and
a minimum value of the Hall Effect Sensor at the calibration temperature value.
